(19) United States
(12) Patent Application Publication
(10) Pub. No.: US 2009/0063990 A1
(43) Pub. Date: Mar. 5, 2009

(54) COLLABORATIVE SEARCH INTERFACE

(75) Inventors: Meredith June Morris, Bellevue, WA (US); Eric J. Horvitz, Kirkland, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/846,863

(22) Filed: Aug. 29, 2007

(51) Int. Cl. G06F 3/00

(52) U.S. Cl. 715/751

(57) ABSTRACT

Systems and methods that enable collaboration among users on a process for information seeking and review. A collaborative search user interface can enable division of tasks among users to mitigate undesired duplication efforts (e.g., parallelize the tasks). Moreover, attribution information associated with the search process/result for each user can be tracked, and users can opine on the search process. Accordingly, both the process and the product of the search can be performed in a collaborative manner.

### BACKGROUND

The emergence of global communication networks such as the Internet and major cellular networks has precipitated interaction between users and other network entities. Today cellular and IP networks are a principal form of communications, and a central means for interacting with other users for various activities. Network users now have mechanisms for searching and or socializing on virtually any topic of interest. Such vast resource of information can also be an impediment for easily locating information as it continues to grow with no end in sight. This presents a formidable challenge when trying to find the information desired; or to locate other users who have similar points of interest.

An example of a network entity that provides social interaction around common subjects is the social network. Social network theory focuses on the relationships and links between individuals or groups of individuals within the network, rather than the attributes of individuals or entities. Generally, a social network can be described as a structure of nodes that represent individuals or groups of individuals (e.g., organizations). Social networking can also refer to a category of network applications that facilitate connecting friends, business partners, or other entities or groups of entities together.

In general, social networks with many weak links are more likely to provide new ideas and opportunities to the network individuals or groups, as compared to closed networks that can have many redundant links such as in a group of individuals who routinely interact, and may already share the same knowledge and opportunities. Accordingly, individuals or groups of individuals of the social network having connections to other social entities are more likely to have access to a wider range of different information, and can function as a source of information that is more relevant to what a user may require. However, given the already vast amount of information available, increasing number of new data sources coming online and the differing types of data being provided, finding these more focused and relevant resources of information such as social networks can be difficult.

In addition, today's web browsers provide limited support for rich information seeking and sharing scenarios. At the same time, Web search is generally considered a solo activity. In general, major search engines (e.g., Google©, Yahoo!©, Windows Live Search) and web browsers (e.g., Internet Explorer, and the like) are typically designed for use by a single person working alone. However, many tasks in both professional and casual settings can benefit from a collective ability to search the web with others. In general, joint and sequential activities by people collaborating on information-gathering tasks are a necessity in such information collection environments.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation provides for collaboration among users on a process for information seeking and review, via a collaborative search user interface. Such collaborative search use interface can display search results (e.g., websites), via a display component associated therewith—as to parallelize the tasks and mitigate undesired duplication efforts. In addition, a mark up component associated with the collaborative search user interface enables users to markup on search results such as adding comments, tags, ratings, and/or high lighting sub-sections of the page, for example. Furthermore, a communication component associated with the collaborative search user interface can provide direct communication channels between users (e.g., when users are searching synchronously), such as over a textual chat or voice channel—wherein exchanged messages can be persistent, to also allow for asynchronous communication. A storage medium can store activities related to the collaboration efforts of the users. Accordingly, both the process and the product of the search can be performed in a collaborative manner.

In a related aspect, a tracking component can track activities for each user such as sites found, keywords used, and the like—wherein the attribution information associated with the search process/result for each user can be logged. As such, users can know which users found which result or suggested what query formulation. Accordingly, relative trustworthiness of information can be evaluated, which can further serve as additional incentive to motivate users. Furthermore, tasks involved can be shared between users who collaborate both on the process and the product of the search, wherein users can function together towards a shared goal.

According to a methodology of the subject innovation, users can initially convene to designate a search category. Such can include entering a user name and pass code to begin the search session. Subsequently, the search task can be divided between users, wherein each user can perform a portion of the task. Next, the users can collaborate with each other as a collective entity, to obtain a shared goal. Hence, each user can plan a respective action and redundant actions (e.g., duplication of the tasks) can be mitigated.

According to a related methodology, upon dividing a task between users, each group member can be notified of activities of other users (e.g., in real time). Hence, users know which group member found which result or suggested which query formulation. As such, users can tab between web browsers and/or switch therebetween, to view the search results and search activities of other users. Subsequently, such results can be persisted and stored in a storage provider, for a subsequent access or evaluation.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of a system that provides for collaboration between users on a process for information seeking and review, in accordance with an aspect of the subject innovation.

FIG. 2 illustrates a further exemplary aspect of a collaborative search system that employs a collaborative search user interface according to a particular aspect of the subject innovation.

FIG. 3 illustrates a particular block diagram of a collaboration system for a process of information seeking and review in accordance with an aspect of the subject innovation.

FIG. 4 illustrates a block diagram for a computer implemented system that facilitates information seeking and review in accordance with an aspect of the subject innovation.

FIG. 5 illustrates a related methodology of collaborating among users in accordance with an aspect of the subject innovation.

FIG. 6 illustrates a related methodology of collaboration on both the process and the product of the search, wherein users can cooperate towards a shared goal in accordance with an aspect of the subject innovation.

FIG. 7 illustrates a particular user interface in accordance with an aspect of the subject innovation.

FIG. 8 illustrates an artificial intelligence (AI) component that can be employed to facilitate generation of contextual information regarding the process and product for a collaborative search in accordance with an aspect of the subject innovation.

FIG. 9 illustrates an exemplary environment for implementing various aspects of the subject innovation.

FIG. 10 is a schematic block diagram of a sample computing environment that can be employed for search collaboration according to an aspect of the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

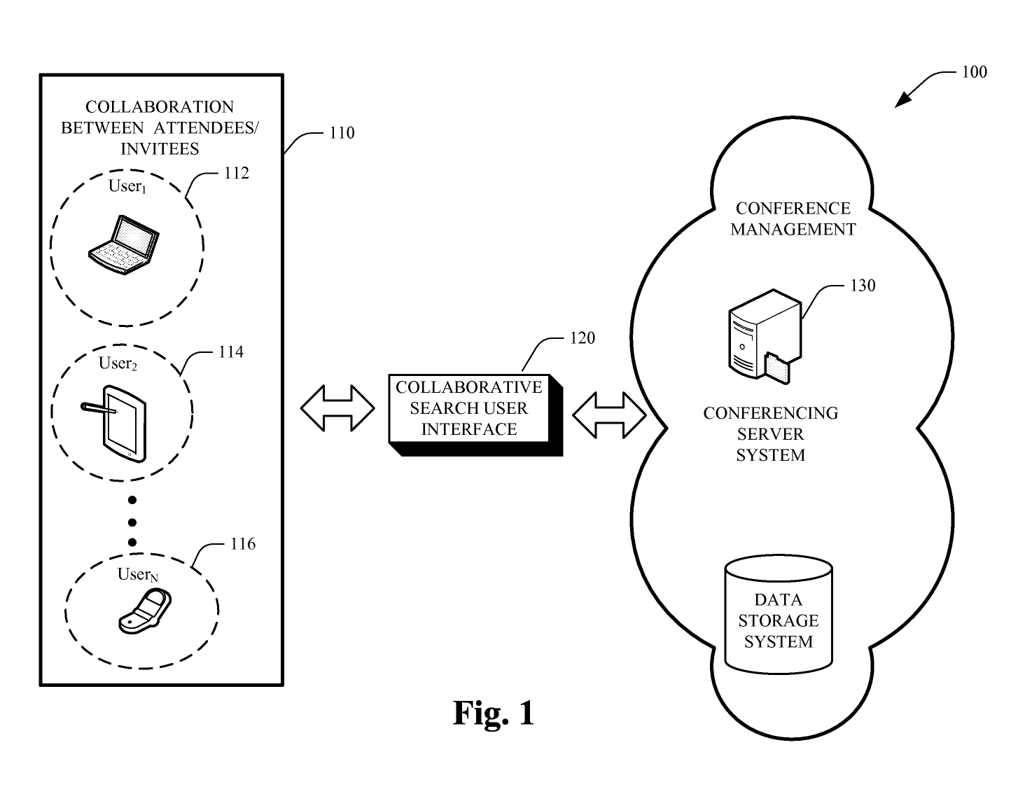

FIG. 1 illustrates a block diagram of a system 100 that provides for collaboration among users on a process for information seeking and review via a collaborative search user interface. Such collaborative search user interface 120 can parallelize tasks involved and further display search results (e.g., websites) at various stages of the search process, to mitigate undesired duplication efforts. The collaborative search user interface 120 further enables documents related to the search to be automatically shared (e.g., through a conference among users thru a session initiation protocol—SIP), wherein users can become aware of search activities of other users.

As illustrated in FIG. 1, the collaboration environment 110 can include a plurality of users, in form of invitees who are invited to a session and convene to pursue a common goal (such as a process for information seeking and review.) Such users can be conference initiators to pursue a common goal in form of participants/users 112, 114, 116 (1 thru N, where N is an integer). The users 112, 114, 116 can also be part of a network (e.g., wireless network) such as a system area network or other type of network, and can include several hosts, (not shown), which can be personal computers, servers or other types of computers. Such hosts generally can be capable of running or executing one or more application-level (or user-level) programs, as well as initiating an I/O request (e.g., I/O reads or writes). In addition, the network can be, for example, an Ethernet LAN, a token ring LAN, or other LAN, or a Wide Area Network (WAN). Moreover, such network can also include hardwired and/or optical and/or wireless connection paths.

For example, a participant/attendee such as a user 112, 114, 116 can initiate a request to perform a search in form of a teleconference/e-mail that is routed through the conferencing server 130 (e.g., voice mail/e-mail server system). A rich contextual form of conference initiation can be supplied, wherein tasks can be divided among the users 112, 114, 116 and/or invitees. As such, both the process and the product of the search can be performed in a collaborative manner.

The users 112, 114, 116 can be part of a network, wherein users 112, 114, 116 can employ: personal computers, workstations, televisions, telephones, and the like, to share connections while cooperating together towards a shared goal. Moreover, such a network can further include one or more input/output units (I/O units), wherein the I/O units can includes one or more I/O controllers connected thereto, and each of the I/O can be any of several types of I/O devices, such as storage devices (e.g., a hard disk drive, tape drive) or other I/O device. The users, I/O units and their attached I/O controllers and devices can be organized into groups such as clusters, with each cluster including one or more hosts and typically one or more I/O units (each I/O unit including one or more I/O controllers). The hosts and I/O units can be interconnected via a collection of routers, switches and communication links (such as wires, connectors, cables, and the like) that connects a set of nodes (e.g., connects a set of hosts and I/O units) of one or more clusters. It is to be appreciated that the wireless communication network among the users 112, 114, 116 can be cellular or WLAN communication network; such as Global System for Mobile communication (GSM) networks, Universal Mobile Telecommunication System (UMTS) networks, and wireless Internet Protocol (IP) networks such as Voice over Internet Protocol (VoIP) and IP Data networks

For example, the portable device employed by users or invitees to the collaboration environment, can be a hand-held wireless communication device that communicate with a wireless communication network, (e.g. wireless communication network) to upload and download digital information, via a cellular access point and/or via a wireless access network (WLAN) access point, such as a cellular base station, mobile switching center, 802.11x router, 802.16x router and the like. Further examples of the portable user devices can include a cellular communication device, a multi-mode cellular device, a multi-mode cellular telephone, a dual-mode cellular device, a dual-mode cellular/WiFi telephone, or like cellular and/or combination cellular/fixed internet protocol (IP) access devices.

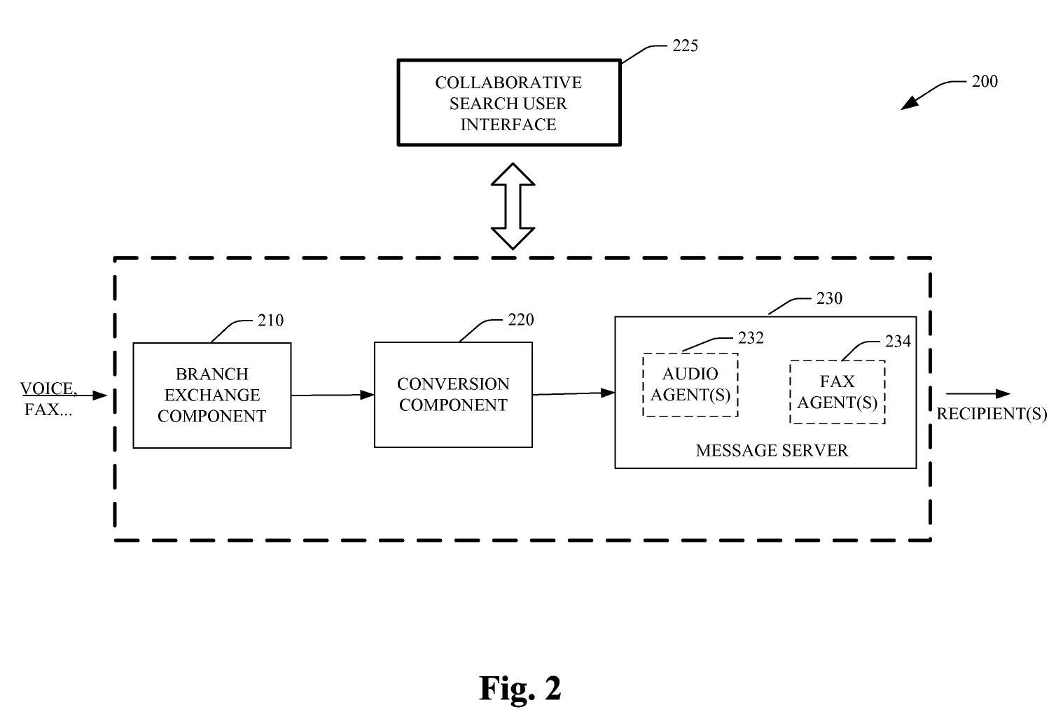

FIG. 2 illustrates a further exemplary aspect of a collaborative search system 200 that employs a collaborative search user interface 225 according to a particular aspect of the subject innovation. The conferencing system 200 can facilitate collaboration among users during a search session. The conferencing system 200 includes a branch exchange component 210 that acquires voice communications, and can include an Intranet protocol (IP) branch exchange (IPBX). Furthermore, the branch exchange component 210 can be public (e.g., central office exchange service) or private (PBX). Accordingly, the branch exchange component 210 can receive communications from conventional telephone systems or over the Internet, among others, via a telephone protocol, IP protocol (e.g., H.323, SIP . . . ) or any other public or proprietary protocol, for searching via the collaborative search user interface 225. Upon receipt of a communication related to search on a common goal among users, the branch exchange component 210 can route the communication to the conversion component 220. For example, the branch exchange component 210 can forward a call that was not answered or a phone number configured to answer a fax to the conversion component 220. The conversion component 220 can receive a communication from the branch exchange component 210 (or via a connection provided thereby), and such conversion component 220 can convert the received communication to an email, regarding the subject of the search. For example, the communications can subsequently or concurrently be transformed into an SMTP (Simple Mail Transfer Protocol) message. As illustrated, the system 200 can further employ the communicator component 225, associated with an office communication server (not shown) that provides a rich set of contextual information about the division of the tasks between the users.

In a related aspect, the conferencing system 200 can incorporate e-mail capabilities as part of its conferencing, wherein a voice or facsimile message can be recorded or saved and provided as an attachment. Furthermore, a portion of the content of the message can be encoded in the body, for instance in a MIME (Multipurpose Internet Mail Extension) format. Additional information can also be captured in the body such as message type (e.g. voice, fax), calling telephone number, voice message duration, voice message sender name, attachment name, fax number of pages and the like. Moreover, the MIME message can subsequently be converted into an internal representation, which can be stored with an internal representation of a message classification. This classification can further be employed by the communicator component 225 to display an optimized UI during the search collaboration, as described in detail infra.

In a related aspect, the conversion component 220 can also be extensible, to employ third party and/or non-native functionality, for instance provided by plug-in components (not shown). For example, such plug-in component can provide algorithms to facilitate translating speech-to-text or for optical character recognition, and hence not all functionality need to be provided solely by the conversion component 220. Accordingly, the conversion component 220 can be updated such that it can employ suitable techniques or mechanisms associated with an invite application or email generation as part of the conferencing system 200, for example.

Also, a generated email or SMTP message can be transmitted from the conversion component 220 to a message server 230. The message server 230 can process messages for delivery to an intended recipient mailbox(es), among other things, such that they can be received or retrieved by an email application (e.g., viewer/editor and POP or IMAP client). For example, the server 230 can correspond to a mailbox, SMTP and/or a bridgehead server. It should also be appreciated that the conversion component 220 can be an SMTP client that communicates with the SMTP server. In addition to forwarding messages to a recipient's mailbox or mailboxes, the message server 230 can filter such messages.

The message server 230 can employ audio agents 232 to scan the audio rather than the text preview of the message. Such audio agents 232 can evaluate based on tone of voice, volume, and/or obscenity checking, among other things. Similarly, fax agents 234 can scan the structure of the email separate from the converted structured document or preview. It should also be noted that these agents 232 and 234 can be plug-ins or add-ons produced by the server vendor or third-party vendors, among others. As explained earlier, the communicator component 225 can supply a rich contextual form of conversation initiation, which holistically addresses requirements for both the inviter and invitee (e.g., a requirement of manual intervention by conference participants, such as attaching documents to e-mails for sharing thereof can be mitigated, and other communication systems are well within the realm of the subject innovation.

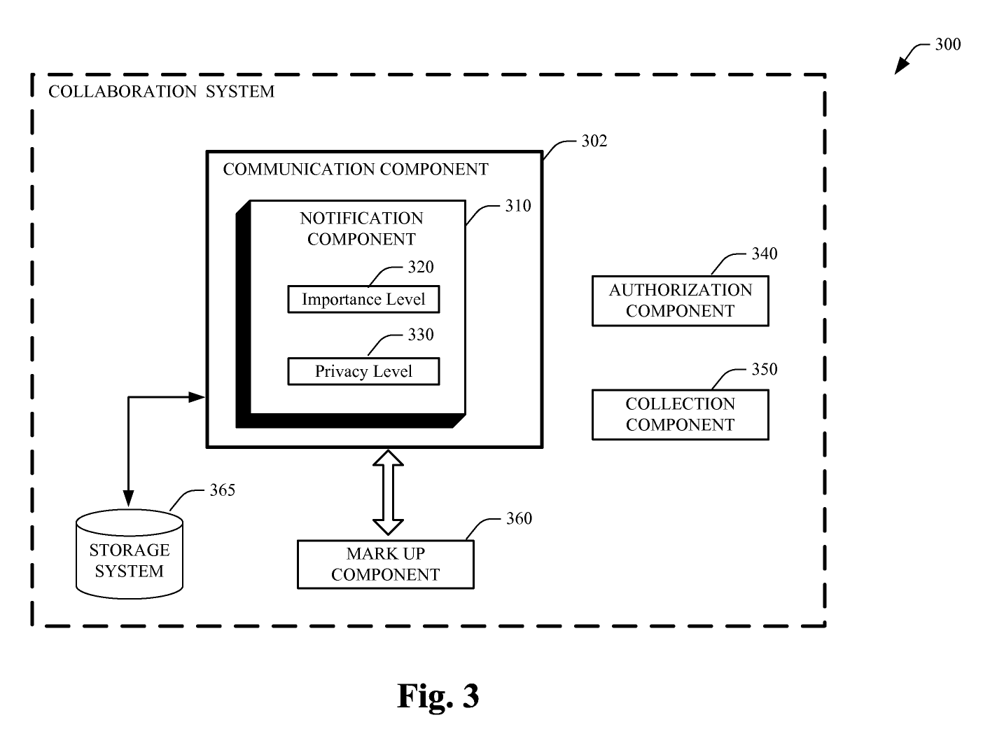

FIG. 3 illustrates a particular block diagram of a collaboration system for a process of information seeking and review in accordance with an aspect of the subject innovation. The communication component 302 can provide direct communication channels between users (e.g., when users are searching synchronously), such as over a textual chat or voice channel, wherein exchanged messages can be persistent, to further allow for asynchronous communication. In addition, a mark up component 360 associated with the collaborative search user interface and as part of the collaboration system 300 enables users to markup on search results such as adding comments, tags, ratings, and/or high lighting sub-sections of the page, for example. Likewise, a storage system 365 can store activities related to the collaboration efforts of the users. Accordingly, both the process and the product of the search can be performed in a collaborative manner.

The communication component 302 can further include a notification component 310 that can transmit an alert to the participants/end points regarding the collaboration among the users (e.g., documents to be searched for, division of activities to be performed, and the like), wherein an invitation to collaborate can also be populated with contextual information regarding the search. In addition, the notification component 310 can set various levels of importance for the users who collaborate for the search (e.g., thru a conference) via a field 320, and further supply information related to the context of the collaboration. Moreover, the notification component 310 enables a user or initiator of the collaboration or conference to set a privacy level 330 for various documents that are to be shared during the collaboration or conference (e.g., access restriction for confidential documents.) The communication can be provided in synchronous manner and in form of an instant message, for example.

The communicator component 302 enables document related to, and/or found during the collaboration to be automatically shared (e.g., through a session initiation protocol—SIP) among the participants of the conference, wherein the communicator component 302 can obtain the name of the document and the location of the document. As illustrated in FIG. 3, an authorization component 340 associated with the collaboration system 300 can apply permissions to allow some users to access some documents and/or messages that are exchanged during the collaboration and further block other users from reaching the exchanged communication. Moreover, a collection component 350 can collect information regarding participants of a conference related to the search, such as names, email aliases, extension numbers, and the like, from a collaboration meeting or agenda, for example. The notice for a collaboration for information seeking and review can be in form of a telephone call initiation, wherein one person dials a telephone number to call another person that can be known or unknown to the person initiating the telephone call. The notice can also include a topic to be searched for via search engines (not shown) discussed by the participants.

Likewise, the collection component 350 can obtain information related to the participants and/or the topic that is to be searched. Information relating to the participants can include information that is generally known (e.g., level of familiarity for formulating a query, level of familiarity with reviewing the concepts, familial relationships, job title, department, supervisor, subordinates, current projects, picture, and the like). Moreover, contextual information related to the topic for the conference can include reports, papers, data related to the topic or authored by a participant/invitee, documents shared between participants, names of other people that have knowledge of the topic and the like.

In a related aspect, the information and associated relationships can be output to the collaboration participants/invitees authorized to view this information. Such information can be presented by output component (not shown), which can present the information in a variety of formats (e.g., visual, audio). The information can be provided before, or during the collaboration.

For example, an invitee may desire to know who else will be attending the scheduled conference. Information regarding other participants can thus be presented as well as the relationship between those participants and the individual requesting the information. Accordingly, the invitee can realize that one of the other participants is working on an unrelated project, yet there exists information that they need to share (e.g., documents, a brief discussion). Upon such determination, the conferencing system 300 can automatically supply the additional document for invitees to the scheduled conference.

Acquiring contextual information (e.g., information related to participants, inferring required documents, determining relationships, and the like) can occur continuously; and information initially collected can be dynamically updated by the collaboration system 300. Thus, if a new search topic is added or a particular project is on going, as new participants are added and/or as participants are deleted, the information can be automatically updated. For example, new information can be posted to a person's profile page and this information can be compiled and output upon request. Accordingly, as participants are added or deleted, the interrelationship between the various participants can change and system 300 can automatically update the visual linking of participants and/or other information associated therewith. As such, the system 300 can transform a collaboration meeting into a vivacious entity that is more than merely a discussion of a common topic but instead is an on-going, dynamic network of contributions and resources that can be selectively exposed and utilized. It is to be appreciated that the collaboration of the subject innovation can occur synchronously or asynchronously.

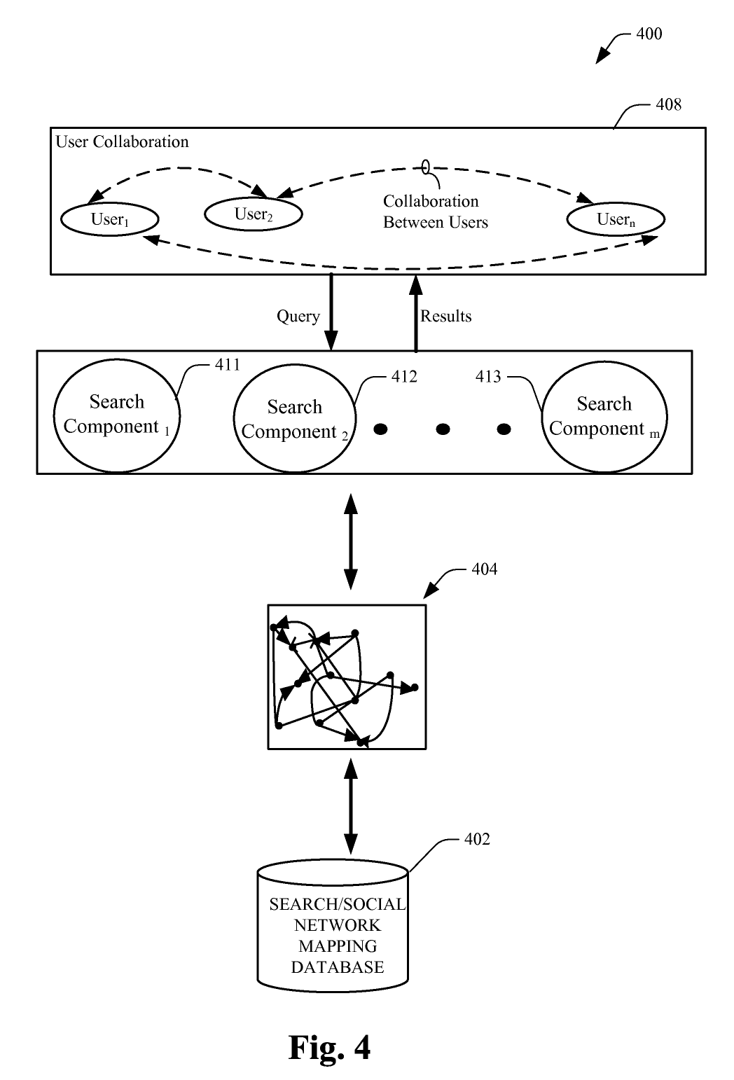

FIG. 4 illustrates a block diagram for a computer implemented system 400 that facilitates information seeking and review in accordance with an aspect of the subject innovation. The system 400 includes a database 402 that stores mapping information 404 that maps user interaction information (e.g., search-related information) to entities on the internet, as defined by a common shared goal between the users (1 thru n, n being an integer). The mapping information 404 can be continuously updated and reorganized, when links/search results within the system mapping are reviewed by users and ranked to indicate a strong or weak link as their relation to the collaboration. Each users can employ a different search component from search components 411, 412, 413 (1 thru m, m being an integer) that includes a search engine (not shown).

The search/social network mapping database 402 can capture both process and products of search, and enable a persistent search session that includes not only the final websites (or sub-portions of websites) that contain the results sought, but also include information such as the keywords and search engine used to find those results (or the path of links and mapping 404 that are followed from a search engine result to the final “useful” site), since this information is helpful to collaborators in understanding both what techniques have already been tried and in understanding how to interpret the authoritativeness or appropriateness of the results. Additionally, pages found “on the way” to the real results are also worth storing, both so that collaborators (or the original user) can avoid duplication of effort by not re-visiting those pages, and so that information found in passing can be relocated later.

It is to be appreciated that there can exist a variety of levels of user collaboration 405 during a search task. For example, very closely-coupled collaboration can imply that all involved parties actively participate in both the search and sense making processes, while a more loosely-coupled collaboration can mean that one person does most of the searching and only shares the results with collaborators. Moreover, detailed data captured and stored in a persistent search session can be beneficial to all involved parties in the closely-coupled scenario, but can be distracting and irrelevant to someone who only wishes to share in understanding the results of an informational search. The ability to create summary views of a persistent session according to an exemplary aspect is valuable for more lightweight collaboration scenarios.

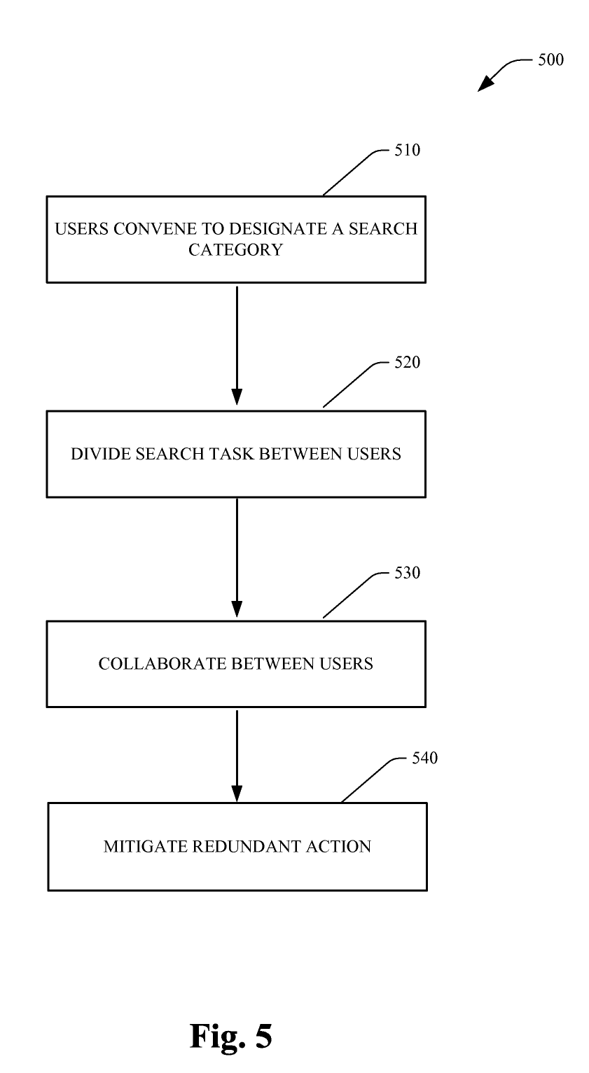

FIG. 5 illustrates a methodology 500 of collaborating among users in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 510 users can convene to designate a search category, such as entering a user name and pass code to begin the search session, for example. Subsequently and at 520 the search task can be divided between users, wherein each user can perform a portion of the task. Next and at 530, the users can collaborate with each other as to obtain a shared goal. Hence, redundant actions (e.g., duplication of the tasks) can be mitigated at 540, wherein each user can plan a respective action.

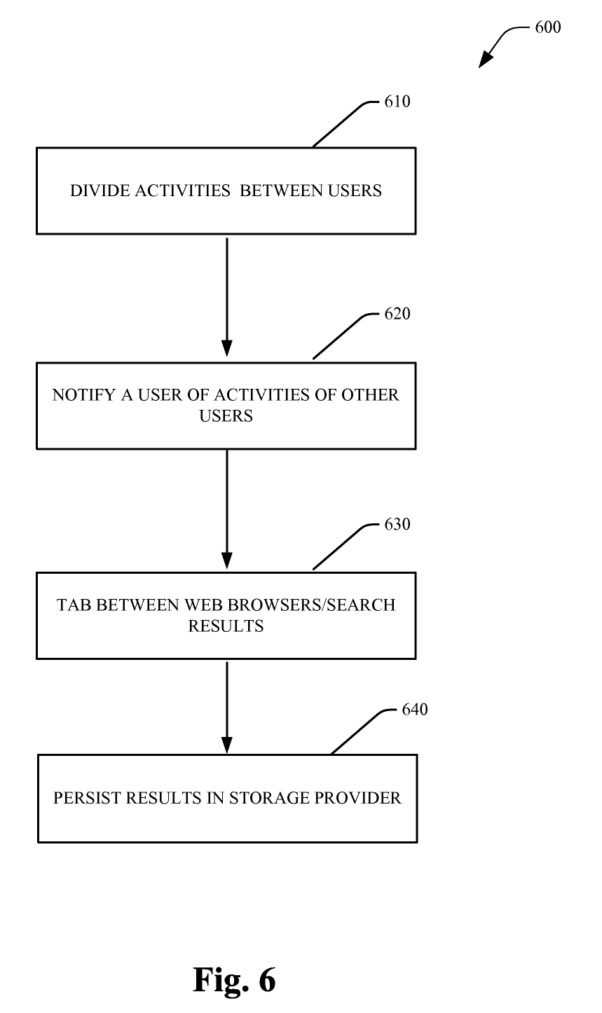

FIG. 6 illustrates a related methodology 600 of collaboration on both the process and the product of the search in accordance with an aspect of the subject innovation, wherein users can cooperate together towards a shared goal. Upon dividing a task between users at 610, each group member can be notified of activities of other users (e.g., in real time) at 620. Hence, users know which group member found which result or suggested which query formulation. Next and at 630, users can tab between web browsers and/or switch therebetween, to view the search results and search activities of other users. Subsequently, such results can be persisted and stored in a storage provider, for access or evaluation at a later time.

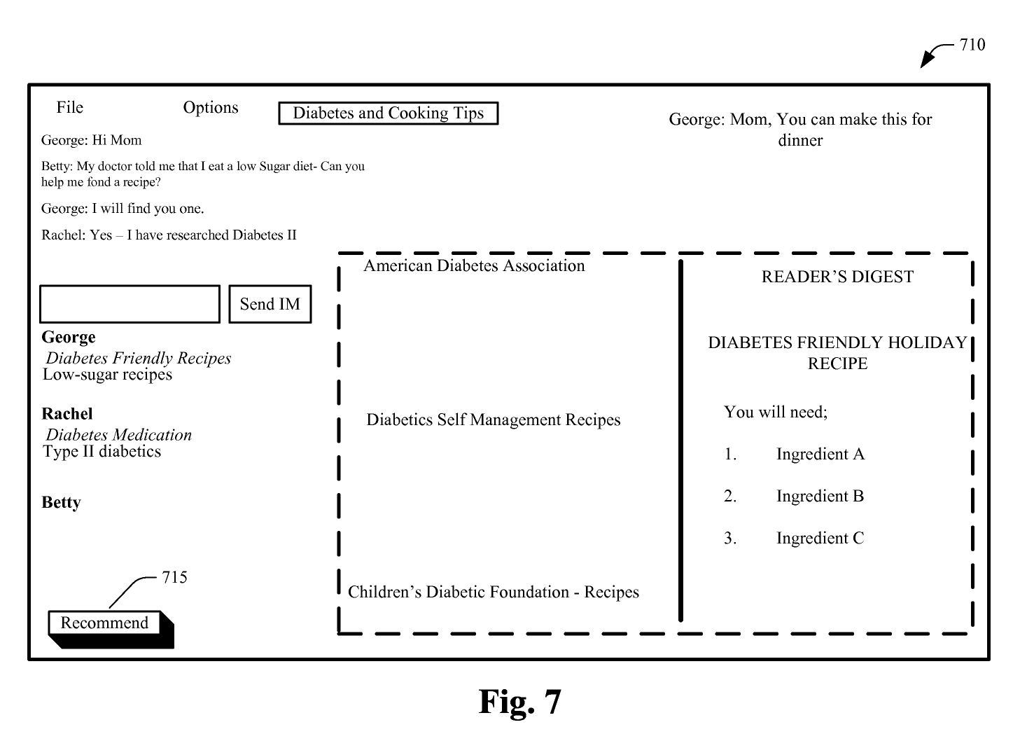

FIG. 7 illustrates an exemplary user interface 710 of the subject innovation as related to the example described in detail below. The collaboration and search together concept of the subject innovation enables either synchronous or asynchronous remote collaboration (e.g., each participant is in a distinct location, with personal computer). User Rachel and her husband George, who reside in New York, learn that George's mother Betty, who lives in California, has recently been diagnosed with diabetes. Betty desires to learn more about the causes of and treatments for her condition, yet she is not a particularly skilled Web searcher. Her son and daughter-in-law are also interested in finding out more about Betty's condition and helping her to learn about the illness. They decide to employ the SearchTogether interface of the subject innovation, to help them communicate and share their findings about diabetes. Rachel logs onto SearchTogether and selects “Create New Session,” entering “diabetes” as the session topic. Next, she is prompted to specify other users who will share the session with her. She chooses George and Betty's IDs from her buddy list. The session is created, and, for now, Rachel is the only member of the group logged in. She performs some standard searches for “type II diabetes” and “diabetes medications.” Her search for medications brings up information on SuperMed, a new treatment shown to be especially effective for patients who have a combination of diabetes and high blood pressure, an ailment that also affects Betty. Rachel clicks the “Recommend” button 715 while viewing the page about SuperMed, selecting Betty as the recipient and entering the comment, “Betty, you should ask your doctor if this medication is appropriate for you! You may want to check if your insurance will cover it.” At a later time, Betty logs into SearchTogether, wherein on the login page, she observes a list of all of the joint search sessions that she is a part of, and she chooses “diabetes” from that list.

Upon logging in, she can observe from the Query Awareness area. Such Query Awareness region can be rendered in gray color (e.g., inactive) if that user is offline. Each time a user executes a search, the query terms used are added to a list underneath user's photo; wherein this history is synchronized across all group members' clients, for example. FIG. 7 illustrates that Rachel has already searched for information on “type II diabetes” and “diabetes medications.” Betty observes a webpage thumbnail in her recommendations queue and clicks on it, which loads the SuperMed webpage into the browser, displaying Rachel's comments above it. Betty prints the page to bring to her doctor's office. An instant message from George (“Hi, Mom!”) appears in the SearchTogether chat window, heralding that George has just logged into the session. Betty sends George an instant message: “My doctor told me that I should eat a low-sugar diet. Can you help me find recipes?” George enters the query “diabetes cooking tips” into his SearchTogether client, and chooses the Split Search option. George's half of the search results appear in his current results tab, and a tab labeled “Live.com search results from George” appears in Betty's client, containing half of the results from George's query. Betty clicks on the tab, and begins exploring the search results.

Meanwhile, George also views several pages, giving thumbs-up ratings to several low-sugar recipes he thinks his mother will enjoy. He can see from the results list that one of the pages also came up in response to one of Rachel's earlier queries, and that she has given it a poor rating, so he skips that one. Several months later, Betty's neighbor, Angela, is diagnosed with the same form of diabetes. Angela mentions to Betty that she is having trouble preparing healthy meals that follow her doctor's guidelines. Betty logs onto SearchTogether, finds the “diabetes” session in her list of joint searches, and opens it up. She adds Angela as a member of the session. Now, Angela can log on and view the session's summary tab, which contains a list of all the pages that Betty, George, and Rachel gave positive ratings to when they conducted their joint search.

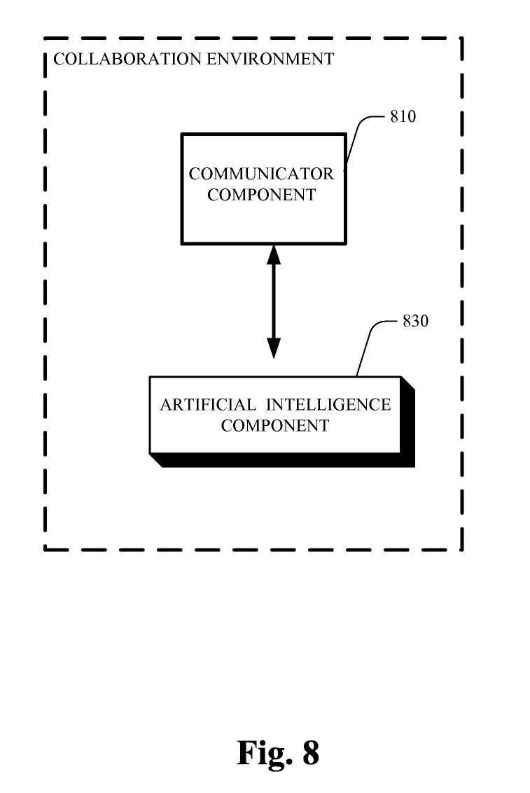

FIG. 8 illustrates an artificial intelligence (AI) component 830 that can be employed to facilitate inferring and/or determining when, where, how to generate contextual information regarding the process and product for a collaborative search in accordance with an aspect of the subject innovation. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 830 can employ any of a variety of suitable AI-based schemes as described supra in connection with facilitating various aspects of the herein described invention. For example, a process for learning explicitly or implicitly how documents and relationships are to be correlated for generation of invitations can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

Accordingly, the communicator component 810 can infer the subject of the collaborative search and/or related conference, and automatically supplies participants with documents related thereto. Moreover, an inference can be made regarding type of end point the invitee is located thereon (e.g., outside a corporate fire wall), and manner that collaborative search documents should be shared (e.g., hyper links, automatic generation of e-mails, and the like). Furthermore, at each stage of the collaborative search or conference, the communicator component can obtain (or supply location) of related documents to the users or invitees to the collaboration.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

As used in this application, the terms “component”, “system”, are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

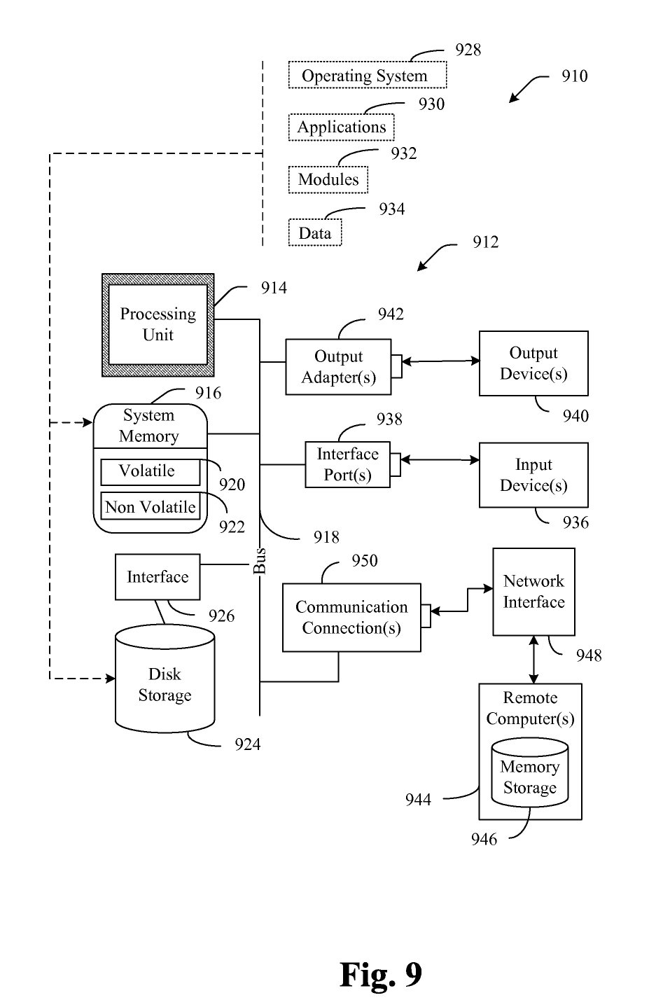

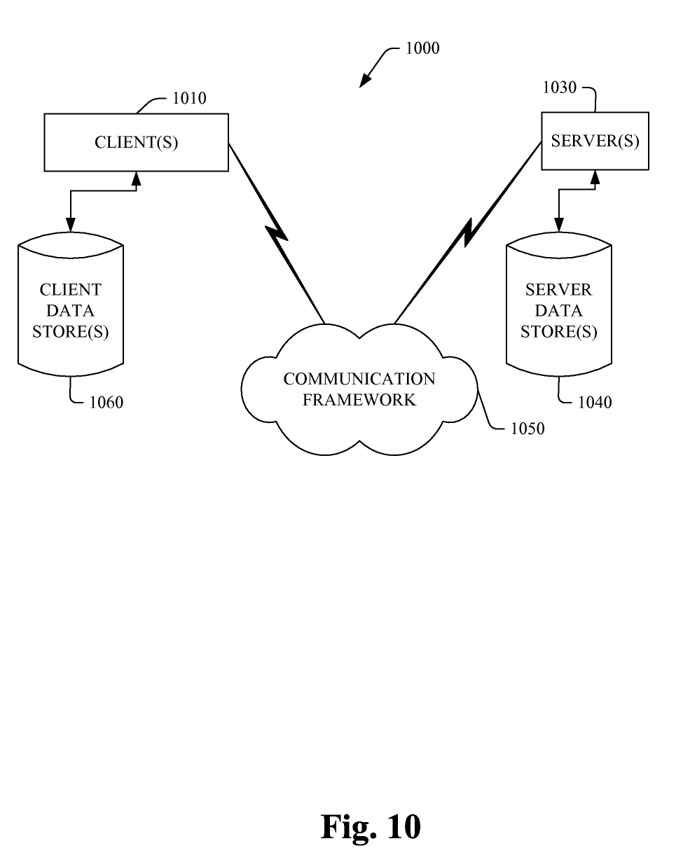

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed for implementing collaboration among users, in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
a search user interface that enables collaboration for process and product of a search between users; and
a storage medium that stores data related to the process and product of the search identified via the search user interface.

2. The computer implemented system of claim 1 further comprising a display component that displays websites associated with the search.

3. The computer implemented system of claim 1 further comprising a mark up component that facilitates mark up on search results.

4. The computer implemented system of claim 3, the mark up further comprising a tag or highlight for subsections of a page associated with the search results.

5. The computer implemented system of claim 3 further comprising a communication component that enables asynchronous communication between users.

6. The computer implemented system of claim 3 further comprising a tracking component that tracks activities for each user.

7. The computer implemented system of claim 3 further comprising a notification component that transmits an alert to the users.

8. The computer implemented system of claim 2 further comprising a collection component that collects information regarding the users.

9. The computer implemented system of claim 2, the storage medium is a database that stores mapping information that maps user interaction information to entities on the internet.

10. A computer implemented method comprising the following computer executable acts:
receiving a search query by a user interface; and
enabling collaboration among users for a process and product of the search, via the user interface.

11. The computer implemented method of claim 10 further comprising dividing tasks associated with the search between users.

12. The computer implemented method of claim 11 further comprising notifying a user regarding activity of another user.

13. The computer implemented method of claim 12 further comprising storing search results.

14. The computer implemented method of claim 12 further comprising collaborating in a synchronous manner.

15. The computer implemented method of claim 12 further comprising collaborating in an asynchronous manner.

16. The computer implemented method of claim 12 further comprising collecting information regarding the users.

17. The computer implemented method of claim 12 further comprising changing interrelationships between users as new users are added.

18. The computer implemented method of claim 17 further comprising populating an invitation to a conference related to the collaboration, with contextual information.

19. The computer implemented method of claim 17 further comprising updating mapping information related to the search.

20. A computer implemented system comprising the following computer executable components:
means for enabling collaboration between users to obtain a shared goal; and
means for storing a storage medium that stores data related to the process and product of the search.
